(19) United States
(12) Patent Application Publication
(10) Pub. No.: US 2009/0324833 A1
(43) Pub. Date: Dec. 31, 2009

(54) METHOD FOR DIRECTLY FORMING PATTERNS ON FACE MEMBRANE BY VACUUM ABSORPTION

(76) Inventor: Lung-Wen Chou, Longjing Township (TW)

Correspondence Address: SINORICA, LLC, 2275 Research Blvd., Suite 500, ROCKVILLE, MD, 20850, US

(21) Appl. No.: 12/555,347

(22) Filed: Sep. 8, 2009

Related U.S. Application Data
(63) Continuation-in-part of application No. 11/776,609, filed on Jul. 12, 2007.

(51) Int. Cl. B05D 1/38

(52) U.S. Cl. 427/278

(57) ABSTRACT

A method for forming patterns on face membrane by air-drawing force when vacuum. A foamed polyurethane (PU) is injected on the surface of substratum cloth to form a face membrane. The face membrane is heated at a preset temperature by a preheating box to be continuously maintained in a softened condition before it is not thoroughly hardened. An airproof release film is attached on one side of the substratum cloth opposite to the face membrane. A roller having functions of vacuum and cooling has its superficial patterns being pressed and printed on the heated face membrane by the air-drawing force when vacuum.

### RELATED APPLICATION

The present application is a continuation-in-part and claims benefit of the co-pending U.S. patent application Ser. No. 11/776,609, Method For Directly Forming Patterns On Face Membrane By Vacuum Absorption, filed on Jul. 12, 2007.

### BACKGROUND OF THE INVENTION

1. Field of the Invention

This invention relates to a PU face membrane, particularly to one having patterns directly formed thereon by means of vacuum absorption.

2. Description of the Prior Art

Referring to FIG. 1, a conventional way of forming a face skin on a basic material is to have substratum cloth 10 conveyed forward on a workbench in a preset direction. The substratum cloth 10 is made of fabric, non-woven fabric, extra fine fiber or the like. A first material-injecting device 20 is positioned above the substratum cloth 10 for injecting PU resin and foaming material on the surface of the substratum cloth 10 to form a PU foam layer 11 and then a first-layer separable paper 12 is pasted on the topside of the PU foam layer 11 by a roller 13 when the PU foam layer 11 is under a gradually reacting condition. After the PU foam layer 11 and the first-layer separable paper 12 are together moved forward for a distance, the first-layer separable paper 12 is stripped off by another roller 14. Next, a second material mixing device 30 is provided above a second-layer separable paper 15 for injecting PU on the surface of the second-layer separable paper 15 to form a face-skin layer 16, and then a third-layer separable paper 17 formed thereon with patterns is pasted on the topside of the face-skin layer 16 by a roller 18 when the face-skin layer 16 is in the course of gradual reaction so as to form patterns on the face-skin layer 16, and then the second-layer separable paper 15 on the underside of the face-skin layer 16 is stripped off by a roller 19. Lastly, the PU foam layer 11 and the face-skin layer 16 are pasted together when they are under a condition of half reaction and half hardening, and subsequently both the PU foam layer 11 and the face-skin layer 16 are moved forward to be closely pressed together by a rolling-and-pasting device 40 and then the finished product is wound up by a winding device.

However, although the conventional basic material 10 and the face-skin layer 16 can be formed together with one round of process, yet in the process, the first-layer separable paper 12 and the second-layer separable paper 15 must be provided for facilitating pressing and pasting of the PU foam layer 11 and the face-skin layer 16, and then they must be stripped off for facilitating combination of the basic material 10 with the face-skin layer 16. In addition, although the third-layer separable paper 17 formed thereon with preset patterns can have its patterns pressed on the face-skin layer 16 by the roller 18, yet the basic material 10 and the face-skin layer 16 are later pressed together by the rolling-and-pasting device 40 under a condition of half reaction and half hardening and thus it is impossible to control the time of half reaction of the half-hardened face-skin layer 16. Therefore, the patterns pressed on the face-skin layer 16 by the third-layer separable paper 17 are easily deformed and cannot be presented perfectly. Moreover, in the producing process, many devices are necessary, thus requiring much space for respectively storing the devices and materials.

### SUMMARY OF THE INVENTION

This invention is devised to offer a method for directly forming patterns on face membrane by vacuum absorption. Firstly, polyurethane (PU), after foamed, is injected on the surface of a substratum cloth to form a face membrane thereon. Next, the face membrane is heated at a preset temperature by a pre heating box to continuously keep the face membrane in a softened condition before it is thoroughly hardened. An airproof release film is afterward attached on one side of the substratum cloth opposite to the face membrane. Then, a roller, having functions of vacuum and cooling, has its superficial patterns quickly being pressed and printed on the heated face membrane caused by the air-drawing force when vacuum. Simultaneously, the patterns on the face membrane is quickly cooled off and printed in shape by the roller, thus avoiding the defects caused by the conventional process for producing synthetic leather and forming patterns on the face skin. By so designing, it is able to shorten a production process, save factory equipment, conform to environmental conservation and economize energy source.

### BRIEF DESCRIPTION OF DRAWINGS

This invention will be better understood by referring to the accompanying drawings, wherein:

FIG. 1 is a flow chart of a conventional way of making synthetic leather;

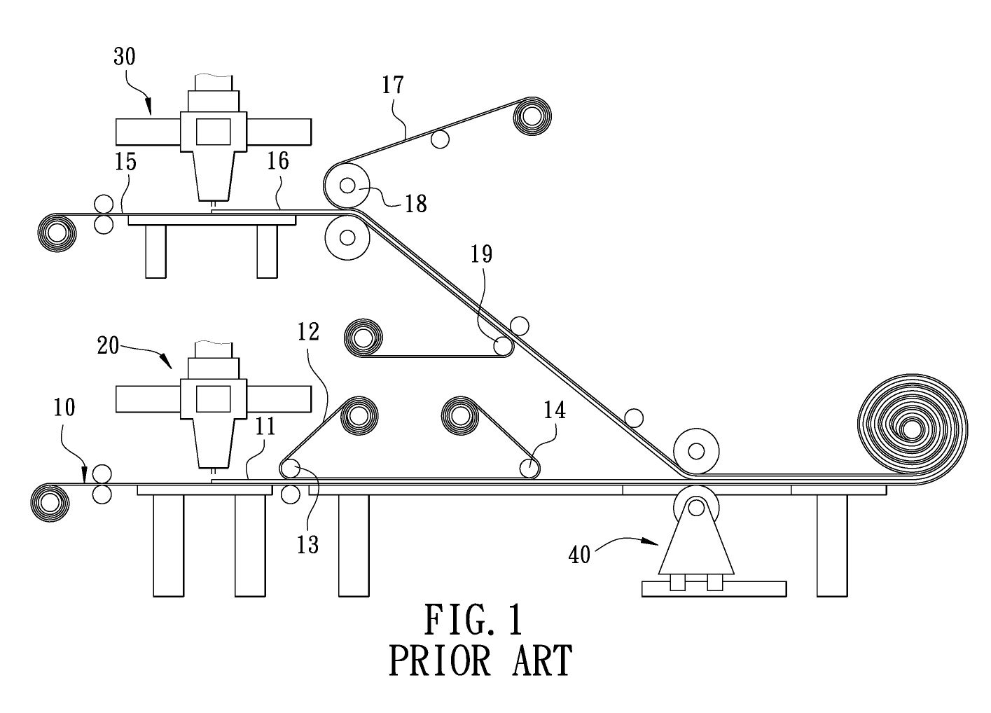

FIG. 2 is a flow chart of a method for directly forming grains on face membrane by vacuum absorption in the present invention; and

FIG. 3 is a cross-sectional view of a roller in a using condition in the present invention.

### DETAILED DESCRIPTION OF THE PREFERRED EMBODIMENT

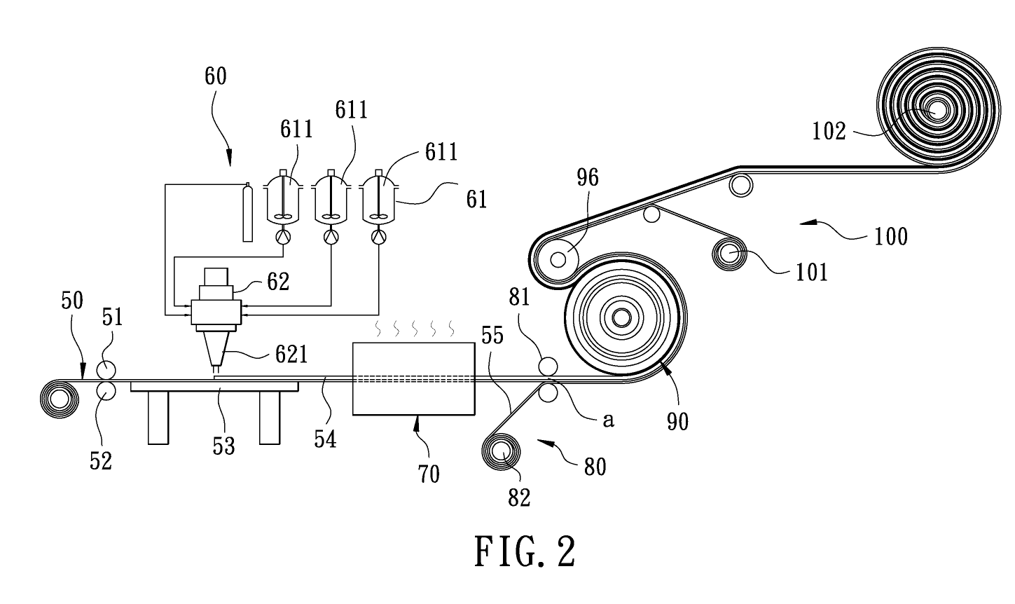

A preferred embodiment of a method for directly forming grains on face membrane by using the air-drawing force of vacuum in the present invention, as shown in FIG. 2, includes the following steps.

A first step is to prepare substratum cloth 50 made of fabric, non-woven fabric, extra fine fiber or the like. The substratum cloth 50 is dragged through and pressed between an upper roller 51 and a lower roller 52 synchronously and conveyed forward neatly along the topside of a work bench 53.

A second step is to provide an injecting installation 60 positioned above the substratum cloth 50 on the workbench 53. The injection installation 60 consists of a material device 61 and a material-mixing device 62, and the material device 61 contains three material tanks 611 respectively filled therein with liquid isocyanate polymer hydroxyl compound, a foaming agent and a pigment. The three material tanks 611 are respectively connected with the material mixing device 62 so that different materials and the foaming agent in the material tanks 611 can be guided to get in the material mixing device 62 to be mixed together to form polyurethane (PU). Then, the polyurethane is quantitatively injected on the surface of the substratum cloth 50 to form a face membrane 54 by a material mixing head 621 of the material mixing device 62.

A third step is to have a preheating box 70 carrying out heating at a preset temperature on the face membrane 54 conveyed to pass through the preheating box 70, and the temperature of the preheating box 70 is preferably not over 150° C. so that the essential quality of the face membrane 54 will not be damaged, and the face membrane 54 will continuously be kept in a softened condition when its surface is heated but not thoroughly hardened.

A fourth step is to provide a compressing roller installation 80 employed to attach an airproof release film 55 on one side of the substratum cloth 50 opposite to the face membrane 54. The compressing roller installation 80 is provided with a roller unit 81 having an gap spaced apart between its rollers for the substratum cloth 50 to pass through, and a pack roller 82 fixed below the substratum cloth 50 for loading a coil of the airproof release film 55, which is made of polyethylene (PE) in this embodiment. The airproof release film 55 is conveyed through the gap ( ) and compressed by the roller unit 81 to attach on the substratum cloth 50.

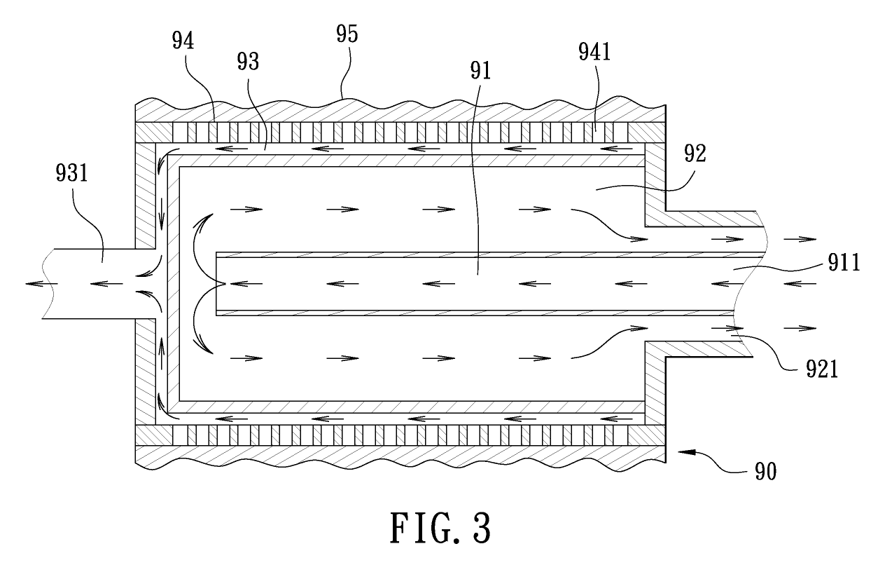

A fifth step is to have a roller 90 rolled on the heated face membrane 54. Referring to FIG. 3, the roller 90 is provided with a water intake pipe 91 orderly disposed from the interior to the exterior, a water outlet pipe 92, an evacuating pipe 93, a metallic outside tube 94 and a forming membrane layer 95. The water intake pipe 91 and the water outlet pipe 92 are respectively provided with a water intake 911 and a water outlet 921 at one end, while the evacuating pipe 93 is provided with an evacuating end 931 at the opposite end of the water intake 911 and the water outlet 921. The metallic outside tube 94 around the outer circumference of the evacuating tube 93 is bored with a plurality of vent holes 941 distributed evenly, and the forming membrane layer 95 covered around the outer circumference of the metallic outside tube 94 is a permeable material made by mixing permeable resin with emery and by means of powder metallurgy. In addition, the evacuating end 931 of the evacuating pipe 93 is connected with an external evacuator (not shown) for producing air-drawing force when vacuum. Thus, by the vent holes 941 of the metallic outside tube 94 and by the air-drawing force of the evacuator when vacuum, the face membrane 54 on the roller 93 can be quickly attached and the patterns of the forming membrane layer 95 on the roller 90 will be quickly and closely pressed on the face membrane 54. Simultaneously, cooling water will flow into the water intake pipe 91 through the water intake 911 and flow into the water outlet pipe 92 and then flow out through the water outlet 921. Thus, after the face membrane 54 is pressed thereon with the patterns, the circulatory cooling water can quickly cool off the face membrane 54 and fix the patterns of the face membrane 54 in shape, and then the face membrane 54 will be neatly wound and sent out by a roller 96 abutting the roller 90.

A last step is to provide a winding device 100 to peel off the release film 55 from the substratum cloth 50 and to wind the substratum cloth 50 separated from the release film 55. The winding device 100 is provided with a first winding roller 101 which is used to wind the release film 55 so as to separate the release film 55 from the substratum cloth 50, and a second winding roller 102 is utilized to wind a final product of the substratum cloth 50 separated from the release film 55.

As can be understood from the above description, this invention has the following advantages.

1. The roller of this invention has functions of quick pressing patterns on the face membrane and quick cooling off the face membrane and fixing the patterns of the face membrane in shape at the same time, avoiding the drawback of the conventional process of producing patterns on the face membrane, in which plural layers of separable paper must be employed for protecting formed face membrane.

2. The process of forming grains on face membrane in the present invention is simplified, able to shorten a producing process, lessen factory equipment, and conform to environmental conservation and save energy source.

While the preferred embodiment of the invention has been described above, it will be recognized and understood that various modifications may be made therein and the appended claims are intended to cover all such modifications that may fall within the spirit and scope of the invention.

I claim:

1. A method for directly forming grains on a face membrane by air-drawing force when vacuum comprising:
a first step of preparing substratum cloth, said substratum cloth conveyed forward in a preset direction;
a second step of arranging an injecting installation at a location above said substratum cloth to be conveyed, said injecting installation injecting polyurethane (PU) on a surface of said substratum cloth to form a face membrane after said polyurethane is formed;
a third step of installing a preheating box provided at a location where said face membrane is conveyed to pass through, said pre heating box carrying out heating on said face membrane at a preset temperature, said face membrane being heated and being kept in a softened condition before said face membrane is thoroughly hardened;
a fourth step of installing a compressing roller installation for attaching an airproof release film on one side of said substratum cloth and opposite to said face membrane;
a fifth step of letting said face membrane rolled and pressed by a roller after said face membrane is heated, said roller vacuums and attachs said face membrane by air-drawing force during the vacuum, said roller having its outside patterns being pressed on said face membrane, said patterns on said face membrane being cooled off and printed in shape by cooling water circulating inside said roller; and
a sixth step of installing a winding device employed to peel off said release film from said substratum cloth and to wind said substratum cloth separated from said release film.

2. The method for directly forming grains on face membrane by air-drawing force when vacuum as claimed in claim 1, wherein said substratum cloth is made of fabric, non-woven fabric, or extra fine fiber.

3. The method for directly forming grains on face membrane by air-drawing force when vacuum as claimed in claim 1, wherein said injecting installation consists of a material device and a material mixing device, said material device composed of material tanks preset in number, said material tanks respectively connected with said material mixing device, various materials mixed and foamed to form polyurethane (PU) in said material mixing device, said material mixing device provided with a material mixing head.

4. The method for directly forming grains on face membrane by air-drawing force when vacuum as claimed in claim 3, wherein said material tanks respectively filled therein with liquid isocyanate polymer hydroxyl compound, a foaming agent and a pigment.

5. The method for directly forming grains on face membrane by air-drawing force when vacuum as claimed in claim 1, wherein temperature of said preheating box is not over 150° C.

6. The method for directly forming grains on face membrane by air-drawing force when vacuum as claimed in claim 1, wherein said roller is provided with a water intake pipe orderly disposed from an interior to an exterior thereof, a water outlet pipe, an evacuating pipe, a metallic outside tube and a forming membrane layer, said evacuating pipe having one end provided with an evacuating end, said evacuating end connected with an external evacuator, said water intake pipe and said water outlet pipe respectively provided with a water intake and a water outlet at one end opposite to said evacuating end, said metallic outside tube bored with lots of vent holes distributed evenly.

7. The method for directly forming grains on face membrane by air-drawing force when vacuum as claimed in claim 6, wherein said forming membrane layer of said roller is a permeable material made by mixing permeable resin with emery by means of powder metallurgy.

8. The method for directly forming grains on face membrane by air-drawing force when vacuum as claimed in claim 1, wherein said compressing roller installation is provided with a roller unit having an interval spaced apart between rollers of said roller unit for said substratum cloth to pass through, a pack roller fixed below said substratum cloth for loading a coil of said airproof release film that is to be conveyed through said interval and compressed by said roller unit to attach on said substratum cloth.

9. The method for directly forming grains on face membrane by air-drawing force when vacuum as claimed in claim 1, wherein said release film is made of polyethylene (PE).

10. The method for directly forming grains on face membrane by air-drawing force when vacuum as claimed in claim 1, wherein said winding device is provided with a first winding roller used to wind said release film so as to peel said release film from said substratum cloth and a second winding roller utilized to wind a final product of said substratum cloth separated from said release film.
